(19) United States
(12) Patent Application Publication
(10) Pub. No.: US 2019/0236558 A1
(43) Pub. Date: Aug. 1, 2019

(54) SYSTEMS AND METHODS FOR DYNAMIC TRANSACTION PROCESSING

(71) Applicant: Walmart Apollo, LLC, Bentonville, AR (US)

(72) Inventors: Spencer Miles, Portland, OR (US); Eytan Daniyalzade, San Francisco, CA (US); Chaitanya Deepak Kulkarni, Fremont, CA (US)

(21) Appl. No.: 15/883,936

(22) Filed: Jan. 30, 2018

(51) Int. Cl. G06Q 20/02; G06Q 20/04; G06Q 20/32

(52) U.S. Cl. CPC G06Q 20/02; G06Q 20/322; G06Q 20/0453

(57) ABSTRACT

Systems and methods are provided to enable the execution of transactions, such as monetary or monetary currency transactions, on a mobile platform, while maintaining compliance requirements. The systems and methods described herein generally includes a server (e.g., management server), an associate computing device, and a client device. The server can communicably couple to a plurality of client devices that are accessible by at least one user to enable the at least one user to communicated with the server. The server can receive at least one request for a transaction from at least one of the plurality of client devices. The server can generate at least one form based on the request that includes a plurality of fields. The serve can transmit the at least one form to at least one of the plurality of client devices to enable at least one user to access the at least one form. The server can receive transaction data associated with the request in the plurality of fields of the at least one form and in response to receiving the transaction data associated with the request, validate the received transaction data in at least one of the fields and process the at least one form when the received transaction data is validated.

### TECHNICAL FIELD

The present disclosure generally relates to financial transactions and, more particularly, to systems and methods for executing financial transactions between individuals.

### BACKGROUND

At least some known financial institutions, such as banks, are involved in money transfers. To extend their geographical coverage, the institutions engage agents and may equip them with specialized terminals or other facilities to facilitate communications necessary for money transfers. At least some known businesses offer money transfer services and other services through a network of agents. A customer that desires to engage in services offered by agents to transfer money to a third party can take the money to an agent of the money transfer service. The agent can accept the money, and obtain necessary information, such as the customer's identity and the identity of the receiver, to initiate the transaction. The money can then be made available to the receiver by another agent.

Many countries have laws and regulations (e.g. compliance requirements) relating to money transfers and similar activities. These compliance requirements can vary with a variety of factors. For example, transaction compliance requirements may vary depending on the country where the transfer originates, the country to which funds are being transferred, the amount of the transfer, and the number of transfers by the customer. Furthermore, compliance requirements may vary the type of information that is collected to complete the transaction, depending on the regulations associated with a specific transaction.

Individuals engaging in money transfers and other services using a network of agents provided by businesses are required to adhere with the various compliance requirements of the transaction. Transaction information must be provided that meets the compliance requirements for each transaction. At least some known methods require an individual to provide additional and/or different information depending on the evolving regulatory nature of money transfer and similar activities. Moreover, forms associated with the collection of individual information must be continuously updated to meet various compliance requirements associated with a respective transaction. As such, transferring money and other related services can be time consuming and inefficient when attempting to comply with regulations.

### SUMMARY OF THE INVENTION

The embodiments described herein enable the execution of transactions, such as monetary or monetary currency transactions, on a mobile platform, while maintaining compliance requirements. In various embodiments, a system is provided comprising a computing device configured to: communicatively couple to a plurality of client devices that are accessible by at least one user to enable the at least one user to communicate with said computing device; receive at least one request from at least one of the plurality of client devices, the at least one request being a request for a transaction; generate at least one form based on the at least one request, wherein the at least one form includes a plurality of fields; transmit the at least one form to the at least one of the plurality of client devices to enable the at least one user to access the at least one form; receive transaction data associated with the at least one request in the plurality of fields of the at least one form; and in response to receiving the transaction data associated with the at least one request: validate the received transaction data by analyzing at least one of the fields of the plurality of fields; and process the at least one form when the received transaction data is validated.

In yet other embodiments, a non-transitory computer readable medium is disclosed, having instructions stored thereon, wherein, when executed by at least one processor, the computer-executable instructions cause the at least one processor to: communicatively couple to a plurality of client devices that are accessible by at least one user to enable the at least one user to communicate with the at least one processor; receive at least one request from at least one of the plurality of client devices, the at least one request being a request for a transaction; generate at least one form based on the at least one request, wherein the at least one form includes a plurality of fields; transmit the at least one form to the at least one of the plurality of client devices to enable the at least one user to access the at least one form; receive transaction data associated with the at least one request in the plurality of fields of the at least one form; and, in response to receiving the transaction data associated with the at least one request: validate the received transaction data by analyzing at least one of the fields of the plurality of fields; and process the at least one form when the received transaction data is validated.

In other embodiments, a method is provided comprising: receiving at least on transaction request from at least one a plurality of client devices accessible by at least one user communicatively coupled to a computing device; generating at least one form based on the at least one request, wherein the at least one form includes a plurality of fields; transmitting the at least one form to the at least one of a plurality of client devices associated with the at least one request; enabling the at least one user to access the at least one form; receiving transaction data associated with the at least one request in the plurality of fields of the at least one form; validating the received transaction data in response to receiving the transaction data associated with the at least one request by analyzing at least one of the fields of the plurality of fields; and processing the at least one form when the received transaction data is validated.

### BRIEF DESCRIPTION OF THE DRAWINGS

FIG. 1A illustrates an exemplary system in accordance with some embodiments of the present disclosure.

FIG. 1B illustrates an exemplary architecture of a mobile device in accordance with some embodiments of the present disclosure.

FIG. 2 illustrates an exemplary transaction flow method that may be used with the system shown in FIG. 1A, in accordance with some embodiments of the present disclosure.

FIG. 3 is a diagram of system server components in accordance with some embodiments of the present disclosure.

FIG. 4 illustrates an exemplary memory storing instruction method that may be used with the system shown in FIG. 1A, in accordance with some embodiments of the present disclosure.

FIG. 5A-5D are example user interfaces for initiating a transaction flow in accordance with some embodiments of the present disclosure.

FIG. 6A-6D are example user interfaces for initiating a send money transaction flow in accordance with some embodiments of the present disclosure.

FIG. 7A-7D are example user interfaces for initiating a receive money transaction flow in accordance with some embodiments of the present disclosure.

### DETAILED DESCRIPTION

The description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

As used herein, use of a singular article such as “a,” “an” and “the” is not intended to exclude pluralities of the article's object unless the context clearly and unambiguously dictates otherwise.

The embodiments described herein provide systems and methods in which individuals may execute transactions, such as monetary or monetary currency transactions, on a mobile platform, while maintaining compliance requirements. The embodiments described herein, include for example, client device dynamically generated forms associated with a respective transaction to facilitate identity and money exchange information necessary for a transaction. The embodiments also provide validation, verification and authentication services for the information exchanged, individual identity, and transaction security. The embodiments further include facilitating additional transactions that comply with the applicable regulations in various jurisdictions by providing systems and methods to minimize the amount of individual time per transaction, while facilitating economically efficient information exchange that does not require additional request for transaction information.

Although the embodiments described herein illustrate dynamic transaction processing systems and methods used for monetary or monetary currency transactions, the embodiments discussed herein are not limited to such systems and methods, and one of ordinary skill in the art will appreciate that the current disclosure may be used in connection with any type of system or method that addresses various different types of information exchange and verification problems.

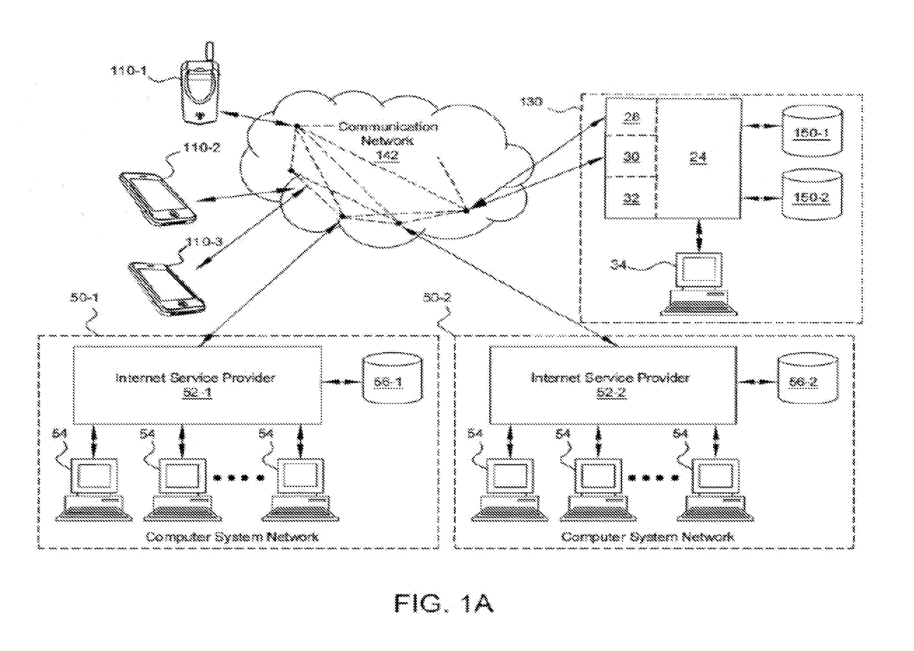

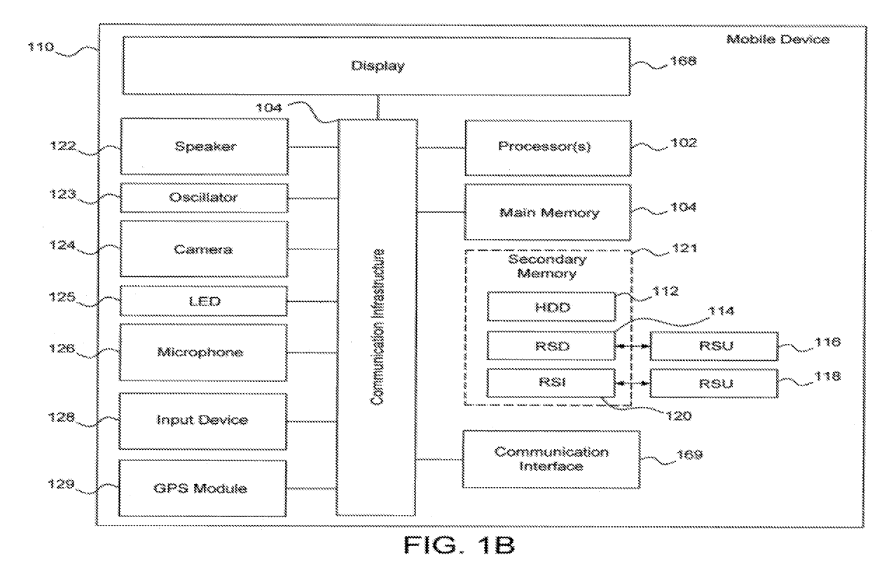

FIG. 1A depicts an example of a system 100 in which a plurality of client devices 110-1, 110-2, and 110-3 (collectively “client devices 110”) are connected via communication network 142 to one or more computer system networks 50-1, 50-2 (“communication networks 50”), and to a management server 130. Communication network 142 may be a wide area network (“WAN”), a local area network (“LAN”), a personal area network (“PAN”), or the like. In one embodiment, communication network 142 is the Internet and client devices 110 are online. “Online” may mean connecting to or accessing source data or information from a location remote from other devices or networks coupled to communication network 142.

Management server 130 includes a processing unit 24 coupled to one or more data storage units 150-1, 150-2 (collectively referred to as “database management system 150” or “DBMS 150”). The processing unit 24, in some embodiments is configured to provide front-end graphical user interfaces (“GUI”) (e.g., client GUI and vendor GUI), and a back-end or administrative graphical user interface or portal to one or more remote computers 54 or to one or more local computers 34. In some embodiments, a client interface (not shown) is provided that accesses management server 130 via a GUI. The GUIs can take the form of, for example, a webpage that is displayed using a browser program local to remote computers 54 or to one or more local computers 34. It is understood that the system 100 may be implemented on one or more computers, servers, or other computing devices. In some embodiments, the GUI may be displayed on client devices 110 via a software application. For example, system 100 may include additional servers programmed or partitioned based on permitted access to data stored in DBMS 150. As used herein, “portal” is not limited to general-purpose Internet portals, such as YAHOO! (“YAHOO!” is a registered trademark of Oath Holdings Inc. of Sunnyvale, Calif.) or GOOGLE (“GOOGLE” and the Google Logo are registered trademarks of Google LLC of Mountain View, Calif.), but also includes GUIs that are of interest to specific, limited audiences and that provide the party access to a plurality of different kinds of related or unrelated information, links, apps and tools as described below. “Webpage” and “website” may be used interchangeably herein.

Remote computers 54 may be part of a computer system network 50-1, 50-2 and gain access to communication network 142 through an Internet service provider (“ISP”) 52-1, 52-2 (“ISPs 52”). Client devices 110 may gain access to communications network 142 through a wireless cellular communication network, a WAN hotspot, or through a wired or wireless connection with a computer as will be understood by one skilled in the art. Clients and vendors, as described below, may use remote computers 54 and/or client devices 110 to gain access to system 100.

In one embodiment, client devices 110 includes any mobile device capable of transmitting and receiving wireless signals. Examples of mobile instruments include, but are not limited to, mobile or cellular phones, personal digital assistants (“PDAs”), laptop computers, tablet computers, music players, and e-readers, to name a few possible devices.

In various embodiments, as described in further detail below, client devices 110 are configured to display dynamic forms or GUIs as part of a transaction flow. In some embodiments, management server 130 of system 100 is configured to generate a transaction receipt (e.g., a ticket, authorization, reference identification, QR code and/or a visual identifier) for a respective transaction. According to some embodiments, as will be described in further detail below, a transaction receipt is a representation of a prospective transaction that has been generated by a user via client devices 110. In various embodiments, client devices 110 and/or computer networks 50 are configured to display or read a transaction receipt for a respective transaction (e.g., a imaging device to read a transaction receipt).

FIG. 1B is a block diagram of one example of an architecture of client device 110. As shown in FIG. 1B, client device 110 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary mobile device 110. After reading this description, it will be apparent to one of ordinary skill in the art how to implement the method using client devices 110 that include other systems or architectures. One of ordinary skill in the art will understand that computers 34 and 54 may have a similar and/or identical architecture as that of client devices 110. Put another way, computers 34 and 54 can include some, all, or additional functional components as those of the client device 110 illustrated in FIG. 1B.

Client device 110 includes a display 168 that displays graphics, video, text, and other data received from the communication infrastructure 104 (or from a frame buffer not shown) to a user (e.g., a subscriber, commercial user, back-end user, or other user). Examples of such displays 168 include, but are not limited to, LCD screens, OLED display, capacitive touch screen, and a plasma display, to list only a few possible displays. Client device 110 also includes a main memory 108, such as a random access (“RAM”) memory, and may also include a secondary memory 110. Secondary memory 110 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114. As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into client device 110. Such devices may include, for example, a removable storage unit (“RSU”) 118 and a corresponding interface (“RSP”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to client device 110.

Client device 110 may also include a speaker 122, an oscillator 123, a camera 124, a light emitting diode (“LED”) 125, a microphone 126, an input device 128, and a global positioning system (“GPS”) module 129. Examples of input device 128 include, but are not limited to, a keyboard, buttons, a trackball, or any other interface or device through a user may input data. In some embodiment, input device 128 and display 168 are integrated into the same device. For example, display 168 and input device 128 may be touchscreen through which a user uses a finger, pen, and/or stylus to input data into client device 110.

Client device 110 also includes one or more communication interfaces 169, which allows software and data to be transferred between client device 110 and external devices such as, for example, another client device 110, a computer 34, 54 and other devices that may be locally or remotely connected to mobile device 100. Examples of the one or more communication interfaces 169 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 169 may also include a wireless interface configured for short-range communication, such as near field communication (“NFC”), Bluetooth, or other interface for communication via another wireless communication protocol. As briefly noted above, one of ordinary skill in the art will understand that computers 34, 54 and portions of system 100 may include some or all components of client device 110.

Software and data transferred via the one or more communications interfaces 169 are in the form of signals, which may be electronic, electromagnetic, optical, or other signals capable of being received by communications interfaces 169. These signals are provided to communications interface 169 via a communications path or channel. The channel may be implemented using wire or cable, fiber optics, a telephone line, a cellular link, a radio frequency (“RF”) link, or other communication channels.

In this document, the terms “non-transitory computer program medium” and “non-transitory computer readable medium” refer to media such as removable storage units 116, 118, or a hard disk installed in hard disk drive 112. These computer program products provide software to client device 110. Computer programs (also referred to as “computer control logic”) may be stored in main memory 108 and/or secondary memory 110. Computer programs may also be received via the one or more communications interfaces 169. Such computer programs, when executed by a processor(s) 102, enable the client device 110 to perform the features of the method discussed herein.

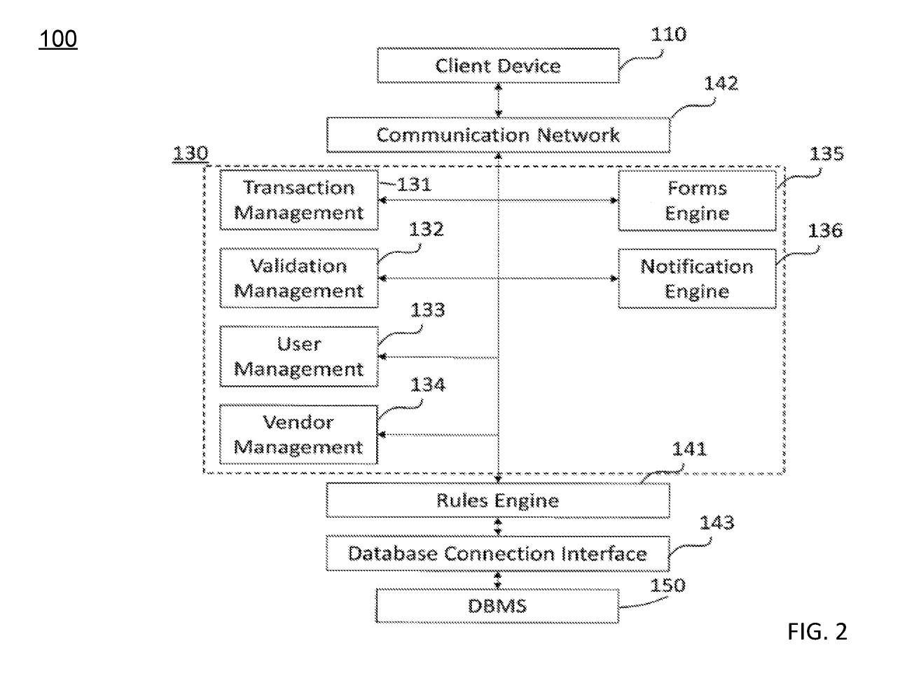

FIG. 2 is a diagram of system 100 management server 130 components in accordance with some embodiments of the present disclosure. In various embodiments, system 100 may be a computing environment including one or more client devices 110, management server 130, one or more software management modules 131, 132, 133, and 134 one or more software engines 135 and 136, database connection interface 143, database management system 150, and a communication network 142 connecting various components of system 100. Although one client device 110 is shown in FIG. 2, any number of client devices may be present. In various embodiments, client device 110 is a user device capable of connecting to the Internet or similar network as will be described below. In some embodiments, at least one client device is a user conducting a transaction on system 100. In various embodiments, as will be described in further detail below, at least one computer network 50 is a third party vendor that fulfills the transaction generated on client device 110.

In various embodiments, as shown in FIG. 2, management server 130 may comprise a rules engine 141 in communication with a database management system 150 via a database connection interface 143. In some embodiments, rules engine 141 is executed by a processor, which reads rules stored in database management system 150 and returns processed rules for use by management modules 131, 132, 133, and 134 one or more software engines 135 and 136. For example, as will be discussed in further detail below, rules engine 141 may be associated with validation management module 132 to perform server-side validation of dynamic forms associated with a transaction flow. Alternatively, rules engine 141 may perform database entry validation for transaction data associated with a transaction flow. As will be discussed in further detail below, for example, transaction management 131 is a module that processes transaction requests from client device 110 via communication network 142 for creating, reading, updating or deleting transactions. In this example, transaction request forms are dynamically generated via forms engine 134 which retrieves a transaction flow via DBMS 150 and returns the dynamically generated form via a GUI to client device 110, as will be discussed in more detail below. It should be appreciated that one or more modules and/or engines that perform the same functions as described herein may be used to achieve the transaction data processes described throughout this disclosure.

Various components of system 100 are configured to address problems associated with financial transactions associated with money or monetary transfer workflows (e.g., updating transaction forms, user information validation, regulatory compliance, and verification). Various components of system 100 address these problems by providing a dynamic mobile transaction management process, secure information storage, and user transaction validation.

In some embodiments, system 100 may comprise a printer (not shown) communicatively coupled to server 100 and/or client device 110. A printer may be any printing device that is used to generate a transaction receipt (e.g., a ticket, authorization, reference identification, QR code and/or a visual identifier) or any other suitable label or marker for determining characteristics of a transaction as described throughout this specification.

In various embodiments, as shown in FIGS. 1A-B, and 2, client device 110 may include a computing device such as a hashing computer, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), or any other suitable computing device configured to store data and software instructions, execute software instructions to perform operations, and/or display information on a display device. Client device 110 may be associated with one or more users (not shown). For example, a user operates client device 110, causing it to perform one or more operations in accordance with various embodiments.

Client device 110 includes one or more tangible, non-transitory memories that store data and/or software instructions, and one or more processors configured to execute software instructions. Client device 110 may include one or more display devices that display information to a user and one or more input devices (e.g., keypad, keyboard, touchscreen, voice activated control technologies, or any other suitable type of known input device) to allow the user to input information to the client device. Client device 110 processor(s) may be any central processing unit (“CPU”), microprocessor, micro-controller, or computational device or circuit for executing instructions. Processor(s) are connected to a communication infrastructure (e.g., a communications bus, cross-over bar, or network). Various software embodiments are described in terms of this exemplary client device 110. After reading this description, it will be apparent to one of ordinary skill in the art how to implement the method using client device 110 that include other systems or architectures. One of ordinary skill in the art will understand that computers may have a similar and/or identical architecture as that of client device 110. Put another way, computers can include some, all, or additional functional components as those of the client device 110 illustrated in FIGS. 1A-B, and 2.

Embodiments of the subject matter described in this specification can be implemented in a system 100 that includes a back end component, e.g., as a data server, or that includes a middleware component, e.g., an application server, or that includes a front end component (e.g., a client device 110) having a graphical user interface or a Web browser through which a user can interact with an implementation of the subject matter described is this specification, or any combination of one or more such back end, middleware, or front end components. The components of the system can be interconnected by any form or medium of digital data communication, (e.g., a communication network 142). Communications network 142 may include one or more communication networks or media of digital data communication. Examples of communication network 142 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet and combinations thereof. In accordance with various embodiments of the present disclosure, communications network 142 may include the Internet and any publicly accessible network or networks interconnected via one or more communication protocols, including, but not limited to, a Uniform Resource Locator (URL), hypertext transfer protocol (HTTP) and HyperText Transfer Protocol Secured (HTTPS) and Secured Socket Layer/Transport Layer Security (SSL/TLS) and transmission control protocol/internet protocol (TCP/IP). Communications protocols in accordance with various embodiments also include protocols facilitating data transfer using radio frequency identification (RFID) communications and/or NFC. Moreover, communications network 142 may also include one or more mobile device networks, such as a GSM or LTE network or a PCS network, allowing a client device to send and receive data via applicable communications protocols, including those described herein. For ease of illustration, communication network 142 is shown as an extension of management server 130.

A client device 110 and server 130 are generally remote from each other and typically interact through a communication network 142. The relationship of client device 110 and management server 130 arises by virtue of computer programs running on the respective system components and having a client-server relationship to each other. System 100 may include a web/application server (not shown) in embodiments used to gain access to many services provided by management server 130.

According to various embodiments, management server 130 is configured to process transaction flows associated with a respective transaction. For example, a transaction flow may be associated with the sending or receiving of a money or monetary transaction. In some embodiments, a transaction flow may be associated with an international or domestic money or monetary transaction. In various embodiments, a transaction flow may be associated with paying a bill or cashing a check. As will be appreciated by one of ordinary skill in the art, a transaction flow may comprise any transaction between various individuals or institutions in which a transfer or transfer process occurs.

As described above, system 100 may comprise remote computers 54 that may be part of a computer system network 50-1, 50-2 and gain access to communication network 142 through an Internet service provider (“ISP”) 52-1, 52-2 (“ISPs 52”). In various embodiments, computer system networks 50-1, 50-2 may represent third party financial transaction vendors. Management server 130 is configured to process transaction flows for a respective user associated with a third party financial transaction vendor. For example, a user may initiate a transaction (e.g., sending money domestically) using client device 110 via management server 130 for a transaction processed via a third party financial transaction vendor via computer system network 50-1. In this example, transaction flow information may be related to the sender, destination, amount, delivery option, third party vendor, recipient, etc. In various embodiments, management server 130 is configured to display, retrieve, store, and process transaction flow information for a respective transaction. In some embodiments, management server 130 is configured to record transaction flow history relating to respective transactions associated with respective users.

According to various embodiments, management server 130 is configured to generate and maintain profiles on users. In some embodiments, management server 130 is configured to retrieve and maintain personal identity information associated with a respective user or transaction data associated with a respective transaction. In various embodiments, user profiles are generated per transaction and maintained on a storage device associated management server 130. In various embodiments, a profile is associated with a type of transaction performed (e.g., domestic transaction to the same recipient, international transaction to the same country, etc.). In other embodiments, a profile is associated with pre-determined characteristics of the transaction (e.g., sender, transaction receiver, destination country, sender's country, etc.). In some embodiments, as described below, profile information may be used to populate fields associated with transaction flow forms without user input. For example, a send money profile would be used to populate screens for GUIs that contain fields relating to sender info, sender address, and/or sender photo identification. In some embodiments, management server 130 is configured to generate and maintain user accounts associated with respective users. In various embodiments, user management 133 of management server 130 performs authentication functions associated with a user account. In this embodiment, user account information may be used to populate the saved transaction profile. In some embodiments, a transaction flow may not be initiated without a user account. It should be appreciated, that user accounts and profiles may be used to process subsequent similar transactions for a respective user streamlining paperwork and minimizing requested information for a transaction flow.

According to various embodiments, management server 130 is configured to stage a transaction. In some embodiments, staging a transaction identifies the transaction flow information necessary for the transaction to process and retrieves the transaction flow information for completing the transaction at a later time. For example, sending money domestically requires identifying sender information, recipient information, destination and amount, conversion rate (if necessary), delivery options, and/or vendor specific information. In various embodiments, management server 130 is configured to stage a transaction by providing dynamic forms via a GUI on client device 110 for inputting transaction flow information. In some embodiments, management server 130 is further configured to provide third party vendor information requests via dynamic forms within a GUI on client device 110. In various embodiments, management server 130 is configured to generate a transaction receipt (e.g., a ticket, authorization, reference identification, QR code and/or a visual identifier) that is associated with the requested transaction flow. In some embodiments, a transaction receipt is used complete a transaction at the point of sale. For example, according to some embodiments, a staged transaction associated with a respective transaction flow generates a transaction receipt in which a client may provide the receipt at the point of sale (e.g., in store, remotely, etc.) to complete the transaction flow.

In various embodiments, a staged transaction may be associated with a store location where the point of sale will occur. In some embodiments, the transaction receipt is associated with the store location that is associated with the staged transaction. In various embodiments, the staged transaction is completed at the point of sale (e.g., in store, remotely, etc.), wherein the information is transferred by management server 130 via vendor management 14 and communication network 142 to a third party vendor for processing the transaction flow.

In various embodiments, a staged transaction may be edited or amended. In some embodiments, an edited transaction creates a new transaction flow wherein profile information is updated. In various embodiments, editing a staged transaction creates a new transaction flow and removes or deletes the previously generated transaction flow. In some embodiments, a staged transaction is live for a predetermined period of time before it expires. In various embodiments, a staged transaction that has expired is no longer available for completion (e.g., unable to complete the transaction at the point of sale). In some embodiments, an expired staged transaction may be renewed. In various embodiments, management server 130 is configured to provide various notifications to a client device concerning a transaction flow via notifications engine 136. For example, a transaction workflow that is unable to be validated by server side validation may notify a respective client device of an error.

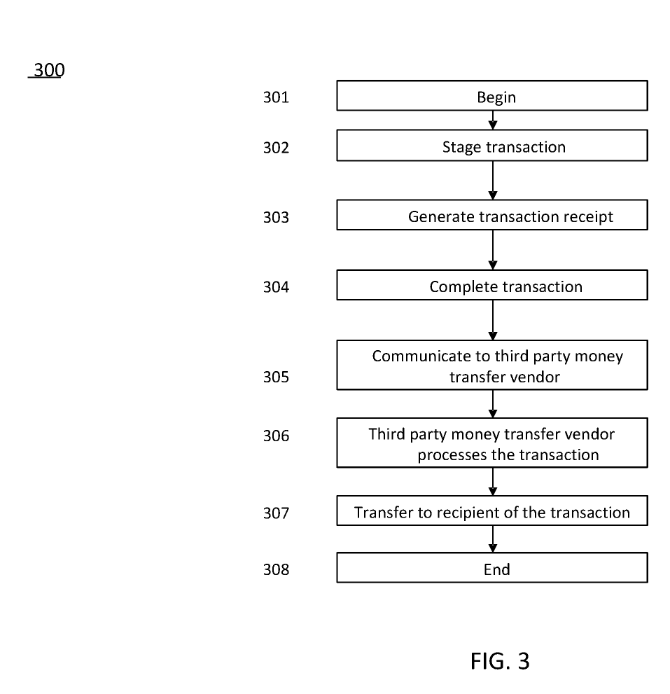

FIG. 3 illustrates an exemplary transaction flow method that may be used with the system shown in FIG. 1A, in accordance with some embodiments of the present disclosure. At 301, the transaction flow process beings. At 302, a user stages a transaction as described above. For example, if a user is sending money, the user may provide information related to the requested transaction flow in the dynamic forms generated by management server 130 via a GUI on client device 110, described further detail below. At 303, management server 130 is configured to generate a transaction receipt (e.g., a ticket, authorization, reference identification, QR code and/or a visual identifier) that is associated with the respective requested transaction flow. In various embodiments, the transaction receipt for a staged transaction is unique to the staged transaction. At 304, the user may complete the transaction by providing the transaction receipt and completing the point of sale associated with the transaction. In various embodiments, the point of sale may be completed in a store that has an association with a third party money transfer vendor. At 305, once the transaction is completed, a completed transaction receipt is generated and management server 130 communicates the respective transaction flow information to a third party money transfer vendor identified in by the user. At 306, the third party money transfer vendor receives the completed transaction receipt and processes the transaction flow information for an in-store money services transaction. At 307, the in-store money services transaction is completed by the recipient of the transaction flow. At 308, the transaction flow method ends.

The resulting processing architecture of system 100 facilitates transactions by permitting users to identify, process, verify, and validate money or monetary transfer transactions. According to various embodiments, system 100 is configured to generate dynamic forms associated with a money or monetary transaction workflow. In some embodiments, dynamic forms may be generated using a Java Script Object Notation (“JSON”) payload. It should be appreciated, that one of ordinary skill in the art will understand that dynamic forms may be generated using various software and/or hardware implementations such as YAML, BSON, MessagePack and the like.

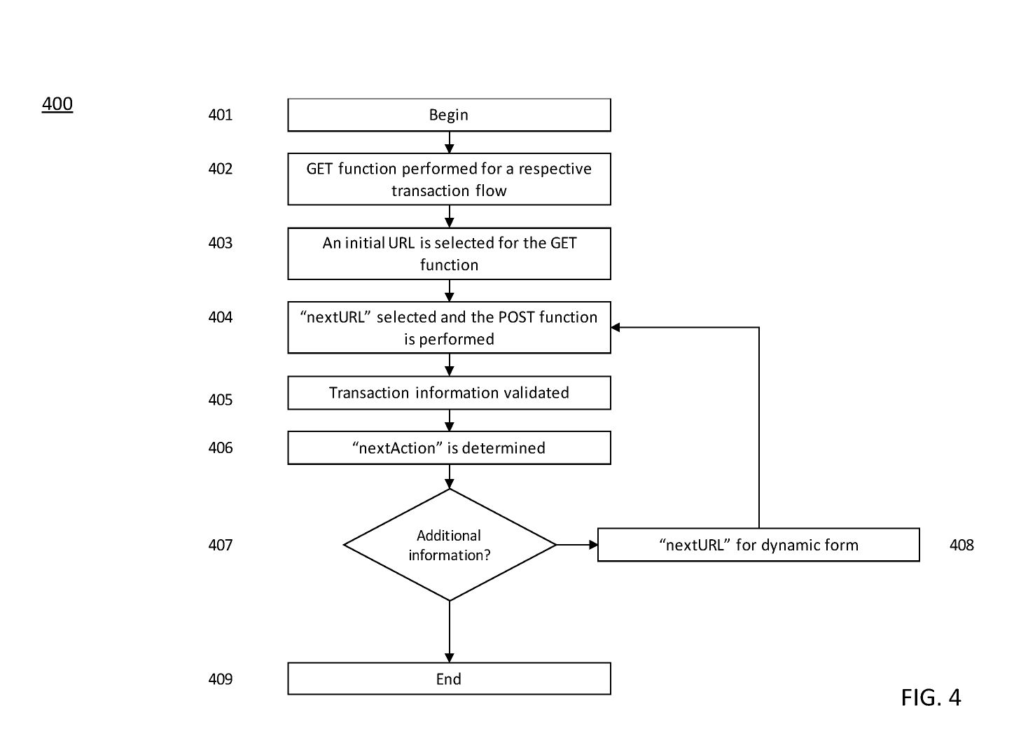

FIG. 4 illustrates an exemplary memory storing instruction method 400 that may be used with the system shown in FIG. 1A, in accordance with some embodiments of the present disclosure. In some embodiments, a transaction flow begins at step 401 with a GET function at step 402 associated with a respective transaction selected by a user via client device 110. In some embodiments, an initial URL is associated with the GET function at step 403. In various embodiments, the GET function and associated initial URL generates a basic, client-side, regex-based validation GUI displayed on client device 110 via forms engine 135 of management server 130. For example, a user may request to send money which begins the send money transaction flow and stores the associated GET function. In this example, the user will input transaction information associated with the send money transaction flow generated by the associated GET function and corresponding initial URL.

In some embodiments, the GET function provides a “nextURL” field, which is used for the POST function, at step 404. Transaction information is provided by a user via client device 110 and inputted in the GUI associated with GET function and associated initial URL at step 403. In various embodiments, the “nextURL” field is labeled “next” or “continue” to indicate a request that the information be utilized in the POST function at step 404. For example, tapping the “nextURL” field (e.g., the “next” button of the GUI) on client device 110 performs the POST function at step 404. The POST function validates information via validation engine 132 of management server 130 on the information inputted by the user via client device 110 in the GUI associated with the GET function at step 405. In various embodiments, the response to the POST function contains a dynamic GUI for the next form associated with the transaction flow 400 based on information provided in the GUI associated with the GET function and initial URL. In some embodiments, the response to the POST function contains a dynamic GUI for the next form associated with the transaction flow 400 independent of information provided in the GUI associated with the GET function and initial URL. Using the send money transaction flow above, the POST function will store information inputted in the GUI by the user associated with the GET function and corresponding initial URL.

At step 406, an associated “nextAction” is determined by transaction management 131 and validation management 132 of management server 130. If an associated action is required at step 407 (e.g., another form is required to obtain additional transaction information), a “nextAction” may be associated with additional dynamic forms associated with a “nextURL” at step 408. In this instance, additional information may be required to process the respective transaction associated with the transaction workflow 400. In some embodiments, management server 130 is configured to identify additional information necessary to process the transaction via transaction management 131. In various embodiments, management server 130 is further configured to provide a “nextAction” function when additional information is necessary to process the transaction. In some embodiments, the “nextAction” function corresponds to a “nextURL” at step 408, which is associated with the respective additional information necessary to process the transaction. At step 408, the “nextURL” generates a GUI on client device 110 for inputting additional information associated with the transaction flow 400. In various embodiments, information inputted at step 408 is subsequently processed by the POST function at step 404 and validated at step 405. When all information necessary to process the transaction has been inputted by the user, the transaction flow ends at step 409. For example, the send money transaction flow starts with a GUI associated with the GET function and initial URL. The user inputs information into the GUI associated with the GET function and initial URL and taps “next” or “continue”. The POST function occurs when the user taps “next” or “continue”, and user inputted information is validated. Additional information may be required to process the transaction, and the “nextAction” and “nextURL” generate a subsequent GUI for the user to input additional information. In this example, a SenderInfo GUI may be associated with a GET function and initial URL. The “nextAction” and “nextURL” at this point are a POST for the SenderInfo GUI. Tapping continue performs the POST function, and the additional information necessary for the transaction may be a photoID GUI associated with a “nextAction” and “nextURL”.

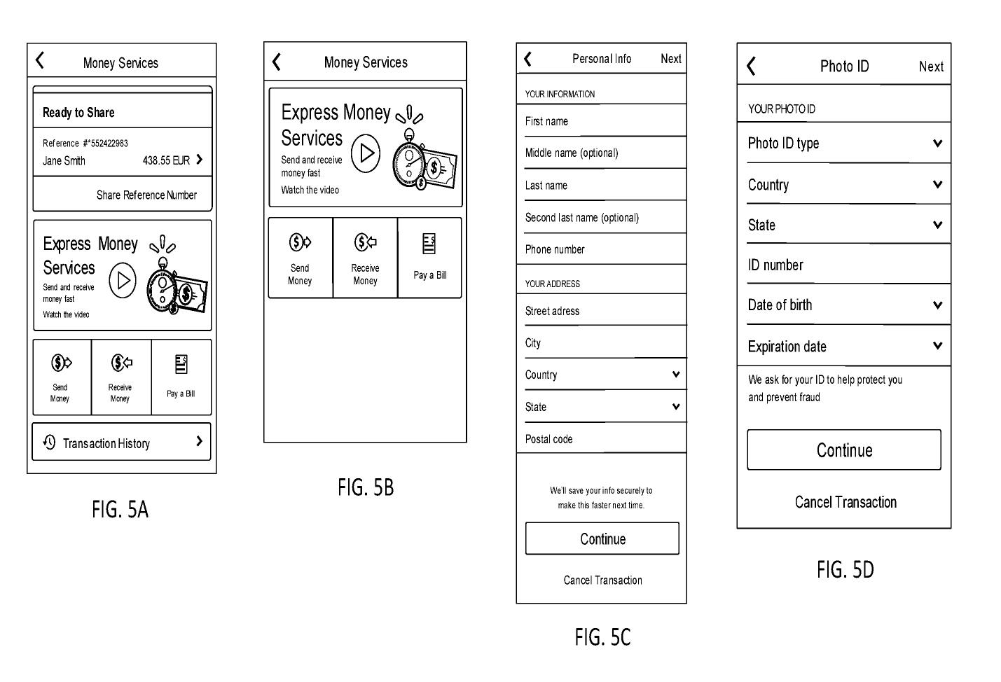

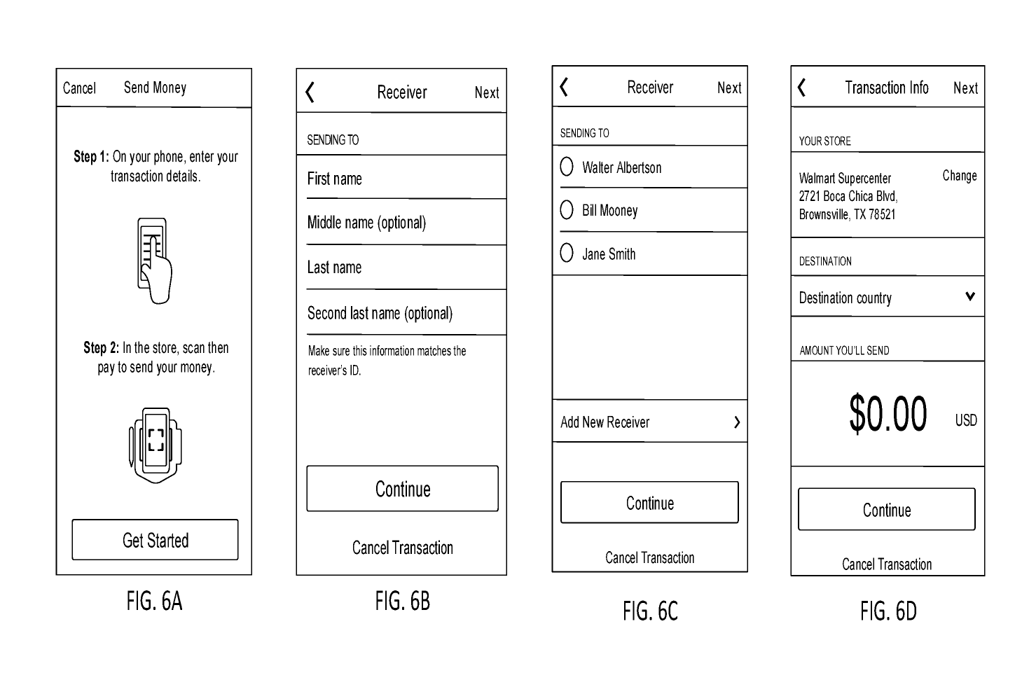

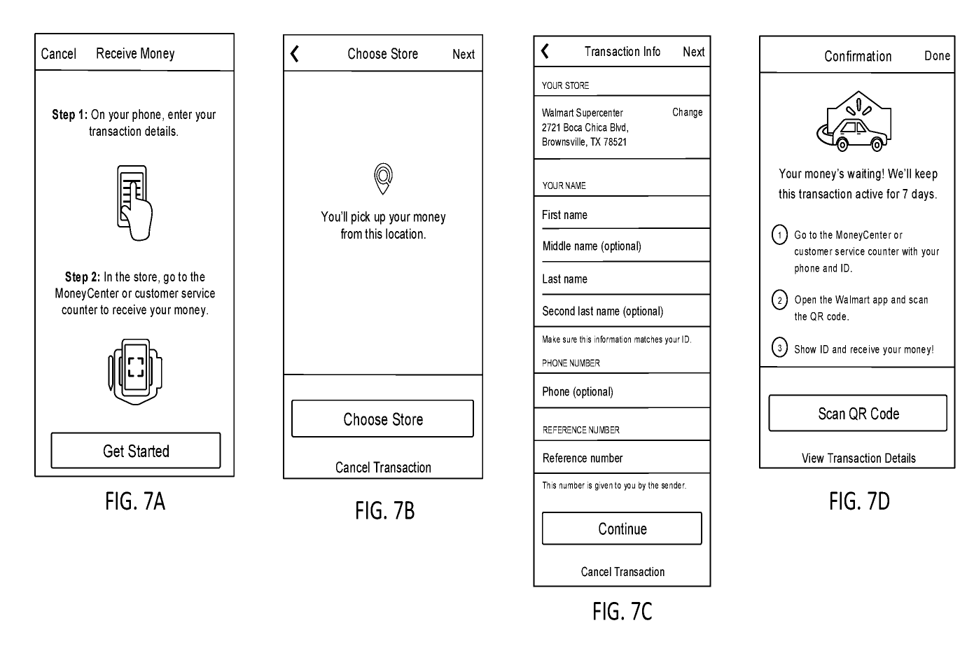

FIG. 5A-5D are example user interfaces for initiating a transaction flow in accordance with some embodiments of the present disclosure. FIG. 6A-6D are example user interfaces for initiating a send money transaction flow in accordance with some embodiments of the present disclosure. FIG. 7A-7D are example user interfaces for initiating a receive money transaction flow in accordance with some embodiments of the present disclosure.

According to various embodiments, management server 130 is configured to perform client-side and server-side validation. In various embodiments, the POST function initiates a server-side validation of GUI information inputted by a user on client device 110 for a respective transaction flow form. In some embodiments, the POST function initiates a client-side validation of GUI information inputted by a user on client device 110 for a respective transaction flow form. In embodiments, validation occurs for both required and optional fields of a GUI associated with a respective transaction flow form. In some embodiments, client-side validation displays errors for associated text input fields that fail validation. For example, a required field may be a first name associated with a transaction receiver (e.g., the person receiving the transaction). Alternatively, an optional field may be a middle name associated with a transaction receiver. In these examples, errors may be displayed that are associated with the required fields of GUI which do not contain information upon validation when a user initiates the POST function by tapping or selecting “next” or “continue”. In various embodiments, for text input fields of the respective GUI, errors are displayed as soon as validation fails, while the text is being inputted. In some embodiments, no error is displayed while text is being inputted when a required field is empty. In some embodiments, a “field is required” error or similar phrase will be displayed for an empty required field upon tapping “next” or “continue”. In various embodiments, a “field is required” error is never displayed for an optional field. In some embodiments, an error will be generated for an incorrect or invalid response to a field. By way of example, a space or number may generate an error for a respective field that would not include a space or number (e.g., a name or country).

In various embodiments, management server 130 is configured to provide server-side validation. In some embodiments, server-side validation is configured to display an error messages when user inputted information is unable to be validated with DBMS 150 of management server 130. For example, when transactions are unable to be validated with a respective vendor associated with computer network 50, management server 130 may provide an error messages to user via client device 110 associated with the respective transaction. In some embodiments, users may be able to attempt to process the transaction by correcting information or identifying additional vendor information. In various embodiments, an error may prevent the transaction from processing.

The various embodiments described herein may employ various computer-implemented operations involving data stored in computer systems. For example, these operations may require physical manipulation of physical quantities usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system. The computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A system comprising:
a computing device configured to:
couple, communicatively, to a plurality of client devices that are accessible by at least one user to enable the at least one user to communicate with said computing device;
receive at least one request from at least one of the plurality of client devices, the at least one request being a request for a transaction;
generate at least one form based on the at least one request, the at least one form includes a plurality of fields;
transmit the at least one form to the at least one of the plurality of client devices to enable the at least one user to access the at least one form;
receive transaction data associated with the at least one request in the plurality of fields of the at least one form;
in response to receiving the transaction data associated with the at least one request:
validate the received transaction data by analyzing at least one of the fields of the plurality of fields; and
process the at least one form when the received transaction data is validated.

2. The system of claim 1, wherein said computing device is further configured: to associate at least one request transaction type with a previously saved transaction user profile.

3. The system of claim 2, wherein at least a portion of the received transaction data is from the previously saved user profile.

4. The system of claim 3, wherein said computing device is further configured to populate at least one of the plurality of fields of the at least one form with received transaction data from the previously saved transaction user profile.

5. The system of claim 1, wherein said computing device is further configured to generate at least one form associated with the received transaction data in response to processing the at least one form when the received transaction data is validated.

6. The system of claim 5, wherein said computing device is further configured to complete the at least one request by communicating transaction data and transaction receipt to a third party money transfer vendor associated with the at least one request in response to processing the at least one form when the received transaction data is validated.

7. The system of claim 1, wherein said computing device is further configured to generate a transaction receipt in response to processing the at least one form when the received transaction data is validated.

8. A non-transitory computer readable medium having computer-executable instructions embodied thereon, wherein, when executed by at least one processor, the computer-executable instructions cause the at least one processor to:
couple, communicatively, to a plurality of client devices that are accessible by at least one user to enable the at least one user to communicate with the at least one processor;
receive at least one request from at least one of the plurality of client devices, the at least one request being a request for a transaction;
generate at least one form based on the at least one request, the at least one form includes a plurality of fields;
transmit the at least one form to the at least one of the plurality of client devices to enable the at least one user to access the at least one form;
receive transaction data associated with the at least one request in the plurality of fields of the at least one form;
in response to receiving the transaction data associated with the at least one request:
validate the received transaction data by analyzing at least one of the fields of the plurality of fields; and
process the at least one form when the received transaction data is validated.

9. The non-transitory computer readable medium of claim 8, wherein the computer-executable instructions further cause the at least one processor to associate a type of monetary transfer with a previously saved transaction user profile.

10. The non-transitory computer readable medium of claim 9, wherein the received transaction data is from the previously saved transaction user profile.

11. The non-transitory computer readable medium of claim 10, wherein at least one of the plurality of fields of the at least one form is populated with transaction data from the previously saved transaction user profile

12. The non-transitory computer readable medium of claim 8, wherein at least one form associated with the received transaction data is generated in response to processing the at least one form.

13. The non-transitory computer readable medium of claim 8, wherein the computer-executable instructions further cause the at least one processor to generate a transaction receipt in response to processing the at least one form.

14. The non-transitory computer readable medium of claim 13, wherein the computer-executable instructions further cause the at least one processor to complete the request by communicating transaction data and transaction receipt to a third party money transfer vendor associated with the at least one request in response to processing the at least one form.

15. A method, comprising:
receiving at least one transaction request from at least one of a plurality of client devices accessible by at least one user communicatively coupled to a computing device;
generating at least one form based on the at least one request, wherein the at least one form includes a plurality of fields;
transmitting the at least one form to the at least one of a plurality of client devices associated with the at least one request;
enabling the at least one user to access the at least one form;
receiving transaction data associated with the at least one request in the plurality of fields of the at least one form;
validating the received transaction data in response to receiving the transaction data associated with the at least one request by analyzing at least one of the fields of the plurality of fields; and
processing the at least one form when the received transaction data is validated.

16. The method of claim 15, further comprising the step of associating an at least one request transaction type with a previously saved transaction user profile.

17. The method of claim 16, wherein at least a portion of the received transaction data is from the previously saved transaction user profile.

18. The method of claim 17, further comprising the step of populating at least one of the plurality of fields of the at least one form with transaction data from the previously saved transaction user profile.

19. The method of claim 16, further comprising the step of generating dynamically at least one form associated with the received transaction data after processing the at least one form when the received transaction data is validated.

20. The method of claim 16, further comprising the step of completing the transaction request by communicating transaction data to a third party money transfer vendor associated with the transaction request after processing the at least one form when the received transaction is validated.
